(19) United States
(12) Patent Application Publication
(10) Pub. No.: US 2022/0360205 A1
(43) Pub. Date: Nov. 10, 2022

(54) Method and apparatus for the start of single-phase induction motors

(71) Applicant: Antonio Ginart, Santa Clarita, CA (US)

(72) Inventors: Julio Viola, La Paz (AR); Jose Restrepo, Cali, CO (US); Jose Aller, Cuenca (EC); Antonio Ginart, Santa Clarita, CA (US)

(21) Appl. No.: 17/315,565

(22) Filed: May 10, 2021

(51) Int. Cl. H02P 27/08; H02P 25/04

(52) U.S. Cl. CPC H02P 27/08; H02P 25/04

(57) ABSTRACT

A method and an apparatus for starting single-phase induction motors (SPIM) is disclosed. The apparatus use a rectifier and a DC-AC power converter, to replace the capacitor required in the startup of SPIM, providing high starting torque and eliminating stator overcurrents. The system uses a contactor to connect the SPIM directly to the AC voltage source once the nominal speed is reached. The disclosed method uses synchronization techniques to assure seamless transition of the SPIM from the power converter to the AC voltage source.

### CROSS-REFERENCE TO RELATED APPLICATIONS

The present application claims the benefits of and priority from U.S. Provisional Application Ser. No. 63/149,260 filed on Feb. 13, 2021, the entire disclosures of which are hereby incorporated by reference in their entirety for all that they teach and for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### FIELD OF THE INVENTION

The present invention relates, in general, to a novel method for starting of single-phase induction motors (SPIM) and an apparatus to be connected to the SPIM where said method is implemented. More particularly, the invention relates to the use of a power converter in conjunction with a contactor, to obtain high startup torque, low starting current with high efficiency during operation.

### BACKGROUND OF THE INVENTION

Single-phase induction motors are widely used in relatively low power applications ranging from fractional to few HP. These motors have two stator windings which are wound physically displaced from each other. The main (also called “run”) winding is designed to operate whenever the SPIM is running, while the auxiliary (also called “start”) winding can be designed for temporal or permanent use, depending on the specific motor. These windings must be fed with currents displaced in phase so that a rotating stator flux can be created and a starting torque can be obtained in the rotor. To obtain this phase displacement several methods have been used typically including the use of one or more capacitors. By far, the most common methods are the so called “capacitor-start” and “capacitor run”, where a capacitor is used in series with the auxiliary winding.

All starting methods based on capacitors suffer of poor torque profile and the presence of high stator currents until the motor reach steady state operation, with starting stator current reaching or surpassing values up to 10 times the nominal value, also called full load amperage (FLA). Another disadvantages associated to these starting methods are degradation of capacitance and increasing rate of failure of capacitors along the time, requirement of connecting/disconnecting devices, high torque pulsations, which lead to mechanical vibrations and damage to the shaft. For three phase motors the concept of soft start has been addressed many decades ago by using AC controllers mostly based on thyristors, which are in charge of gradually increase the rms voltage applied to the stator windings so overcurrents are limited. Once the AC controller output gradually reach the nominal voltage, typically thyristors are bypassed with relay(s) or contactor(s) so thermal losses in the semiconductors are minimized. Due to the inherent way of operation of thyristors, it is difficult for the AC controller to change the frequency of output voltage applied to the motor and the resulting start process is slow because the starting torque reduces quadratically with the reduction of stator voltage. As additional drawbacks, stator overcurrent is not completely eliminated, and harmonic distortion of the currents seen by the AC power source is high. In single-phase induction motors this starting method is not practical since the capacitor still is needed to obtain the shift in the line current phase, and the switching of capacitive circuits leads to high currents when the thyristors are turned-on. Due to this, no soft starters based in this operating principle are reported for SPIM.

The use of variable frequency drives is widely reported in the starting and control of three phase motors. Typically based on a rectifier and a voltage source inverter (VSI), this kind of solutions can synthesize a voltage output that can be controlled in magnitude, frequency and phase, leading to a myriad of different control schemes for motor speed, torque and position.

U.S. Pat. No. 6,121,749 filed in Sep. 19, 2000 by Wills et al. discloses a variable speed drive for single-phase motors which operates permanently connected to the motor.

U.S. Pat. No. 6,051,952 filed in Apr. 18, 2006 by Moreira et al. discloses an electric motor speed and direction controller which is based on a half bridge inverter and a triac allowing control of speed and direction but with no soft start characteristics.

U.S. Pat. No. 7,061,204 filed in Jun. 13, 2006 by Unno et al. discloses a starter circuit using a triac and a PTC thermistor to obtain reduced power consumption during the single-phase motor startup. The disclosed circuit still needs the starting capacitor and do not implement soft start.

### BRIEF SUMMARY OF THE INVENTION

This summary is provided to introduce concepts in a simplified form that is further explained in the detailed description of the disclosed invention. The goal of this summary is not to identify key or essential inventive concepts of the claimed subject matter, nor is it intended for determining the scope of the claimed subject matter. A method and an electronic apparatus for starting of SPIM is disclosed, where the main and auxiliary windings of the SPIM are used for starting. During starting, the apparatus feeds the motor windings with variable frequency and voltage coming from a pulse width modulated power converter, when the steady state speed is reached main and common terminals are directly connected to the line and neutral of the AC voltage source. A synchronization technique is used to assure seamless transition from the power converter to the line power. The power converter operates only during the startup of the SPIM, remaining bypassed the rest of the time, leading to a very reliable, safe, and efficient operation of the disclosed system. The invention solves problems found in other SPIM start circuits such as: high inrush current in the beginning of the motor startup, poor torque characteristics during startup typical of the SPIM, mechanical vibration due to distorted current waves, need of run and/or start capacitors, need of additional components such as relays/contactors, centrifugal contactors and PTC thermistors. The disclosed invention combines ideas from the fields of power electronics, electric machines, and systems control, being general enough to be used in almost any application where rapid and reliable startup of a SPIM is required.

### BRIEF DESCRIPTION OF THE DRAWINGS

FIG. 1 is an electrical scheme of a SPIM with a “capacitor-start” topology.

FIG. 2 is an electrical scheme of a SPIM with a “capacitor-run” topology.

FIG. 3 is a general diagram of blocks showing the connection of the disclosed starter to a single-phase induction motor.

FIG. 4 is a detailed view of diagram of blocks shown in FIG. 3 showing an embodiment of the disclosed starter for single-phase induction motors.

FIG. 5 is a general flow chart for the starting method according to the current disclosure.

### DETAILED DESCRIPTION OF THE INVENTION

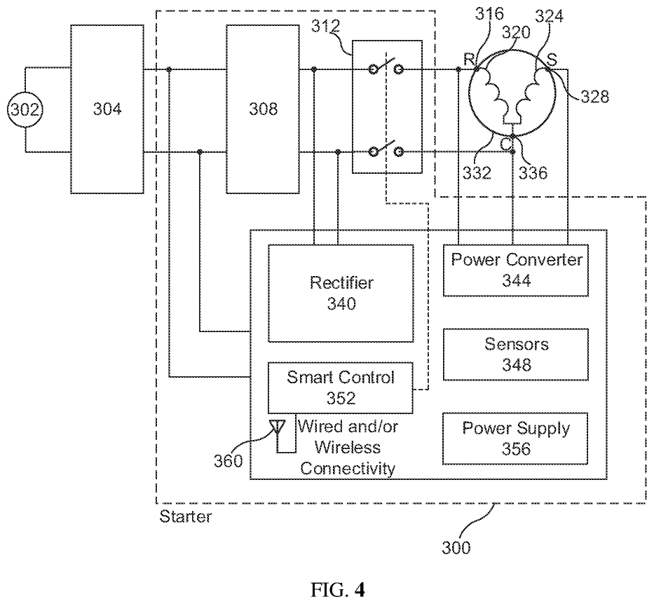

The terminology used herein is for the purpose of describing a particular embodiment only and is not intended to be limiting in any way. A possible embodiment of the invention is presented below with reference to the FIG. 4, notwithstanding, those skilled in the art will appreciate that the detailed description given herein with respect to FIG. 4 is for explanatory purposes as the invention extends beyond this embodiment, and several alternate approaches can be devised, depending on the particular motor application and power.

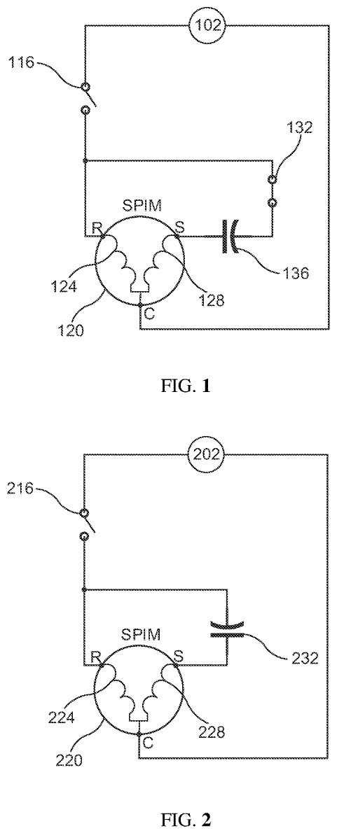

In FIG. 1 a classic “capacitor-start” circuit is shown, where the single-phase AC source 102 is connected by means of the switch 116 to the main winding 124 of the SPIM 120. To obtain the initial rotating stator flux, the switch 132 connects the starting capacitor 136 in series to the auxiliary winding 128 of SPIM 120. After the rotation of the motor is initiated the switch 132 is open and the oscillating stator flux is enough to maintain the motor running. The time when the switch 120 opens depends on specific characteristics of the set motor-load. Also the method used to open the switch 132 is different depending on the application, and motor power.

In FIG. 2 a “capacitor-run” topology is shown, where the AC power from 202 is applied through switch 216 to the main winding 224 of SPIM 220. A run capacitor 232 is permanently connected to the auxiliary winding 228 of SPIM 220. Run capacitors have typically less capacitance that start capacitors and are designed for continuous duty, being energized the entire time the motor is running. Combinations of “capacitor-start” and “capacitor-run” topologies can be found in some applications. Both topologies however have as drawbacks the presence of high startup currents which remain until the SPIM reach the steady state operation.

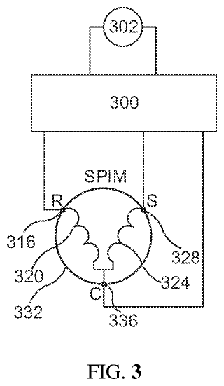

Referring to FIG. 3, the figure shows a general connection diagram with the disclosed starter 300 connected to a SPIM 332 and to the AC source 302. The output of the starter 300 are connected to the terminals (R) 316, (S) 328, and (C) 336 of the main winding 320 and auxiliary winding 324 of SPIM 332.

FIG. 4 shows a detailed diagram of blocks for a exemplary embodiment of the disclosed starter 300. Voltage input 302, is the utility power line or any other source of AC voltage which supplies power to the system. The connection may or may not require a protection breaker 304 depending on the specific type of electric installation. The rectifier 340, takes the AC voltage from the utility power line and generates DC voltage which is fed to the DC bus of the power converter 344. Depending on the voltage level of AC source 302 and power of SPIM 332, the topology of rectifier 340 may vary. Also depending on electric regulations the rectifier 340 may include power factor control capabilities. To the output of breaker 304 is also connected a power supply 356, which provides the required voltage levels to feed the sensors stage 348 and smart control stage 352. Inside smart control stage 352 a microcontroller is in charge of generating the on-off pulses for the power switches inside power converter 344, using pulse width modulation. The output of the power converter is connected to the terminals of the SPIM 332, where terminal (R) 316 corresponds to the run winding 320 and terminal (S) 328 corresponds to the start winding 324. The terminal (C) 336 is the common for both windings. The pulse width modulation implemented in the microcontroller inside 352 allows the creation of rotating stator flux in the SPIM 332 which generates high starting torque. The microcontroller also uses a variable modulating signal for starting the SPIM 332. After the SPIM 332 has reached the steady state speed, the output of the power converter 344 is shutted down and the microcontroller inside 352 activates the contactor 312, letting the SPIM 332 to run directly connected to the AC voltage 302. To ensure a seamless transition the smart control may use one or more electric measurements coming from the sensors stage 348 to synchronize the power converter output voltage with the voltage coming from the AC source 302 and to decide the best moment to close the contactor 312. The sensed variables inside 348 may include AC voltage at 302, DC voltage at the output of rectifier 340, current in main winding 320, current in auxiliary winding 324, motor case temperature, and rotor speed.

The contactor 312 may be implemented with several options depending on requirements. One option is to use one electromechanical contactor with a double-pole single-throw configuration or two electromechanical contactors with a single-pole single-throw configurations. For both cases the microcontroller inside 352 is in charge of controlling the on/off status of the contactor(s). Another option is to use solid state AC switches, which have faster response than electromechanical contactors. A possible implementation for the solid state switch is by using TRIACs and/or antiparallel thyristors. The main disadvantage of solid state switches are the inherent greater losses produced in the silicon, so another option may be a combination of parallel electromechanical and solid state contactors, by means of which the solid state contactor is first turned on, followed by the electromechanical contactor. After the electromechanical contactor is effectively closed, the solid state contactor may be open to reduce the losses. Stage 308 may be added to limit electromagnetic interference and thus comply with specific electrical regulations. As in the case of the power factor controller in the rectifier 340, different topologies may be used for stage 308 depending on the requirements.

Referring to the power converter 344 its DC bus is fed by the DC voltage provided by the rectifier 340 and it may have different topologies according to different possible embodiments. In some embodiments the power converter may be a 2-level, 3-legs inverter, where the midpoint of each leg is connected to each of the three terminals in the SPIM 332. In other embodiments the power converter 344 may be a 2-level, 2-legs inverter (also known as H-bridge), where the midpoint of each leg is connected to terminal 316 (R) and terminal 328 (S). Remaining common terminal 336 (C) may be connected to a midpoint in the DC bus, which may require to split the DC bus into two halves. Another possible embodiments may use multilevel inverters with 2 or 3 legs configurations, such as a 3-level neutral point clamped (NPC), cascaded H-bridges (CHB), among others. For these possible embodiments, the smart control 352 may generate different pulse width modulation techniques depending on several design constraints such as SPIM nominal voltage and/or power and/or speed. For all mentioned topologies the power converter 344 can generate the rotating stator flux required for high starting torque, ensuring at the same time no overcurrents. Referring to the electronic power switches inside any of the topologies for the power converter 344 described before, they may be, but not limited to, IGBTs (insulated gate bipolar transistors) or MOSFETs (metal-oxide-semiconductor field effect transistors). Typically MOSFETs may have better efficiencies and costs for low power starters (<1 HP), while IGBTs are better options for higher power. Also silicon carbide (SiC) and/or gallium nitride (GaN) power switches may be used. Although not preferred, GTOs (gate turn-off thyristors) and IGCTs (insulated gate-commutated thyristors) may also be used depending on the specific requirements of the applications where the starter will be used. In every topology described before, the power converter 344 operates only during the startup of the SPIM, ensuring a soft acceleration for the SPIM from standstill to nominal speed, and after this speed is reached, the motor is directly connected to the AC source 302. This unique feature gives to the disclosed invention high efficiency with lower implementation costs because the power converter does not require to be full rated. The same reasoning apply for other stages such as the rectifier 340, DC bus filter, and power factor control.

According to other exemplary embodiments, the disclosed invention may include wired and/or wireless connectivity 360, allowing interface with industrial networks and/or smart home environments. Through this wired and/or wireless connection, the embodiment may use the contactor 312, which enables the starter 300 to perform load shedding and load management operations if it is required by an external system. Also, through the wired and/or wireless connectivity 360, the system may be externally polled by means of a user interface to obtain health status of the SPIM 332, as well as stored notifications about the system's behavior during the last startups, such as: aborted attempts, shutdowns due to over and undervoltages, overcurrents, and overheating in the SPIM 332. Examples of wired and wireless protocols that may be used for the connectivity are, but are not limited to, MODBUS, CAN, TCP/IP, WiFi, BlueTooth, ZigBee, among others. Examples of devices that can be used to communicate with the system may be, but are not limited to, laptops, smartphones, and/or industrial communication equipment.

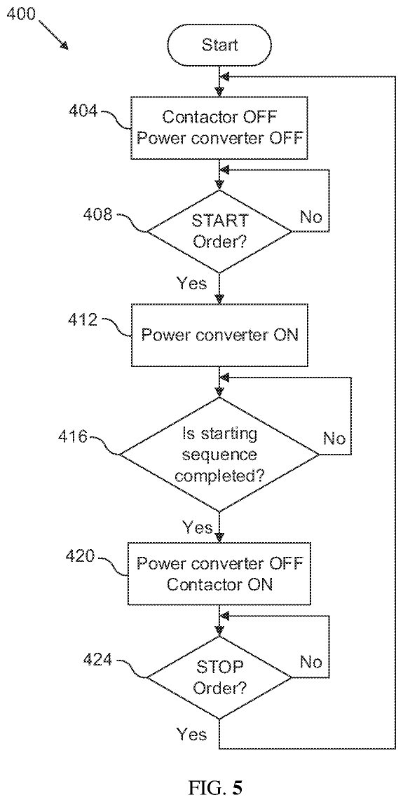

Referring to FIG. 5, a flow chart 400 for the disclosed starting method is shown. The following example starting sequence is merely illustrative and is in not intended to limit the method disclosed herein. The process start in step 404 by assuring contactor 312 is open and power converter 344 has all electronics switches in open status. After that, the method continues with step 408, where it waits for an external start order to be received. This order may come from different sources depending on the specific application of the starter. For example if the SPIM 332 is used in refrigeration applications, this order may be the thermostat closing. In another example this order may come from an internal or external timer, which is set to turn on and off the SPIM following a certain timetable. In another example the order can be sent through the user interface by using wired or wireless connectivity. In all this examples after the starting order is received the method continues at step 412, while if no order is received, the method stays in a loop within the step 408. In step 412 power converter 344 is turned on, which may include charging the DC bus capacitor to the required voltage level and enabling the circuitry driving the power switches. The method continues at step 416 where pulse width modulation is used in the microcontroller inside 352 to generate the firing pulses for the power converter 344. Different techniques may be used to obtain the pulse width modulation which leads to variable magnitude, frequency, and phase of the voltage at the outputs of the power converter 344. For example a sinusoidal pulse width modulation where magnitude and frequency of the modulating signal have constant relationship may be used. Another examples are field oriented techniques, direct torque control, and current direct control, which may be suitable depending on the operating conditions and applications of the SPIM 332. The microcontroller inside 352 may determine by different means when the starting sequence has finished, for example by having preset startup times determined empirically, or by measuring the stator current in the SPIM. While the sequence is not finished the method keeps in the step 416 and when it finishes the method continues at step 420. In this step the power converter 344 is turned-off before the contactor 312 receives the order to close, thus avoiding conflicting voltages at the terminals of SPIM. The microcontroller may use one or more measurements coming from 348 to adjust the pulse width modulation, thus synchronizing the power converter output voltage with the AC voltage 302. The measurements from 348 also may be used to determine the best moment to turn-off the power converter 344 and close the contactor 312, assuring seamless transition of the SPIM from the power converter to the AC voltage 302. These techniques may include zero crossing detection of the line voltage and/or zero crossing detection of the SPIM stator current, so that the transient of current seen by AC voltage source 302 is minimized or eliminated. The method continues at step 424, staying there until a stop order is received. This order may be generated by several sources depending on the specific application, for example external orders coming from thermostats or timers, or an internal order if the microcontroller detects malfunctioning in the SPIM (such as overheating or overcurrent) or in the AC voltage source 302 (such as over or undervoltage). When the stop order is received the method returns to step 404 where the contactor 312 is open and the sequence will start again when the startup order is received. Along the whole sequence one or more settings may be adjusted based on operational assumptions to achieve a better performance of the starter 300. For example some parameters that may be adjusted include, but are not limited to: switching frequency of the power converter, rate of change for the magnitude of voltage and/or frequency applied by the power converter 344 to the SPIM 332, and delays for the closing and/or opening of the contactor 312. With the disclosed invention the starting current of the SPIM 332 is gradually incremented from zero to the required load amperage due to the pulse width modulation applied to the power converter output voltages, achieving at the same time high starting torque and replacing the capacitor required in classic starting circuits for SPIM. The power converter 344 operates just during the startup of the SPIM, after that, the SPIM is directly connected to the AC power source through contactor 312. This a fundamental difference from the operation of a variable frequency drive, where the power converter is permanently connected to the SPIM. The disclosed invention provides an unique and very efficient manner to start SPIM in a wide range of power and applications, overcoming limitations found in prior art where full-time and/or full-rated converters are used to control electric motors.

What is claimed is:

1. An apparatus for safe and reliable start of single-phase induction motors (SPIM) comprising:
a rectifier taking power from the AC line voltage and feeding a DC bus of a power converter;
the said power converter which feed main and auxiliary windings of the said SPIM;
a contactor which bypasses the said power converter connecting the said SPIM directly to the AC line voltage.

2. An apparatus according to claim 1, wherein the said power converter is controlled by a smart control stage to apply variable frequency and voltage to the main and auxiliary windings of the said SPIM to produce high starting torque with reduced startup currents.

3. An apparatus according to claim 1, wherein the starting of the said SPIM is done without the need of starting and/or run capacitor, and disconnecting devices for the starting capacitor.

4. An apparatus according to claim 1, further comprising health diagnosis of said SPIM with real-time monitoring of, but not limited to, AC line voltage, SPIM stator current, SPIM stator voltage, and SPIM case temperature.

5. An apparatus according to claim 1, further comprising an enabling interface with smart home and smart industries installations requiring, but not limited to, load shedding, load management, and alarm notifications.

6. An apparatus according to claim 1, further comprising protection capabilities for the said SPIM including AC line under and overvoltage, and overcurrent.

7. A start method for said SPIM comprising:
feeding main and auxiliary windings of said SPIM with a pulse width modulated voltage;
the transfer of the said SPIM to the AC line voltage by means of a contactor.

8. A method according to claim 7, further comprising the synchronization between the pulse width modulation of the said power converter and the AC line voltage, to obtain a seamless transition of the SPIM between the output of the power converter and the AC line source.

9. A method according to claim 7, further comprising the adaptation of the start sequence to adapt to SPIM with different parameters.

10. A method according to claim 7, further comprising the implementation of health monitoring for the said SPIM and for the system can be implemented.
